(19) United States
(12) Patent Application Publication
(10) Pub. No.: US 2012/0224027 A1
(43) Pub. Date: Sep. 6, 2012

(54) STEREO IMAGE ENCODING METHOD, STEREO IMAGE ENCODING DEVICE, AND STEREO IMAGE ENCODING PROGRAM

(76) Inventor: Yousuke Takada, Kobe-shi (JP)

(21) Appl. No.: 13/391,258

(22) PCT Filed: Aug. 20, 2009
(86) PCT No.: PCT/JP09/03970

§ 371 Date: May 14, 2012

(51) Int. Cl. H04N 13/02

(52) U.S. Cl. 348/46; 348/E13.074

(57) ABSTRACT

The stereo image encoding device 10 of the present invention comprises a frequency transformation unit 21 that converts first image data, obtained from a first viewpoint, into a first frequency component that is divided based on a predetermined frequency range and resolution, and converts second image data, obtained from a second viewpoint, into a second frequency component that is divided based on a predetermined frequency range and resolution, a corresponding relationship analysis unit 22 that compares the first image data and the second image data and analyzes the corresponding relationship, a parallax compensation unit 23 that, based on the corresponding relationship, selectively performs symmetrical parallax compensation on the first frequency component and the second frequency component by means of rotation processing and obtains a parallax-compensated first frequency component and a parallax-compensated second frequency component, and an encoding unit 24 that, based on the analyzed corresponding relationship, selectively encodes the first frequency component, the second frequency component, the parallax-compensated first frequency component, and the parallax-compensated second frequency component.

### TECHNICAL FIELD

The present invention pertains to a stereo image encoding method, stereo image encoding device, and stereo image encoding program for encoding stereo image data obtained from two different viewpoints.

### PRIOR ART

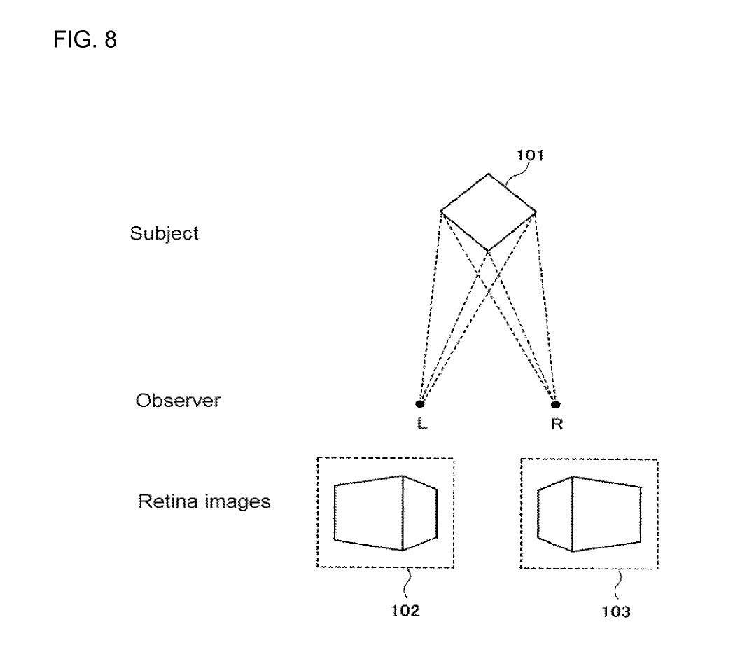

Three-dimensional display systems for displaying video with three-dimensional depth include, for example, the polarizing filter system, the color filter system, the time-multiplexed system, etc. (see non-patent document 1). All of the systems, for example, as shown in FIG. 8, present different videos of a subject 101 to the left and right eyes of a human who is viewing the video so that an image 102 projected on the retina of the left eye and an image 103 projected on the retina of the right eye are different, and achieve stereoscopic vision due to the difference in position or viewing direction of the subject, specifically, the binocular parallax, that can be seen by the right eye and the left eye.

Methods such as MPEG-2 MVP (Multiview Profile) and MPEG-4 AVC MVC (Multiview Coding) can be used for encoding two viewpoints. These methods use parallax compensation (view compensation), which resembles motion compensation, and utilize redundancy between viewpoints (see non-patent documents 2, 4, 5).

Specifically, multiview image encoding devices have been disclosed which encode either the left or right viewpoint image as a base view image that can be independently decoded, and encode the image of the other viewpoint as a non-base view image that can be parallax compensated by reference to the base view image (for example, see patent document 1). This sort of parallax compensation is executed asymmetrically with the reference source image and the resulting image classified according to the viewpoint, so it is known as asymmetric parallax compensation.

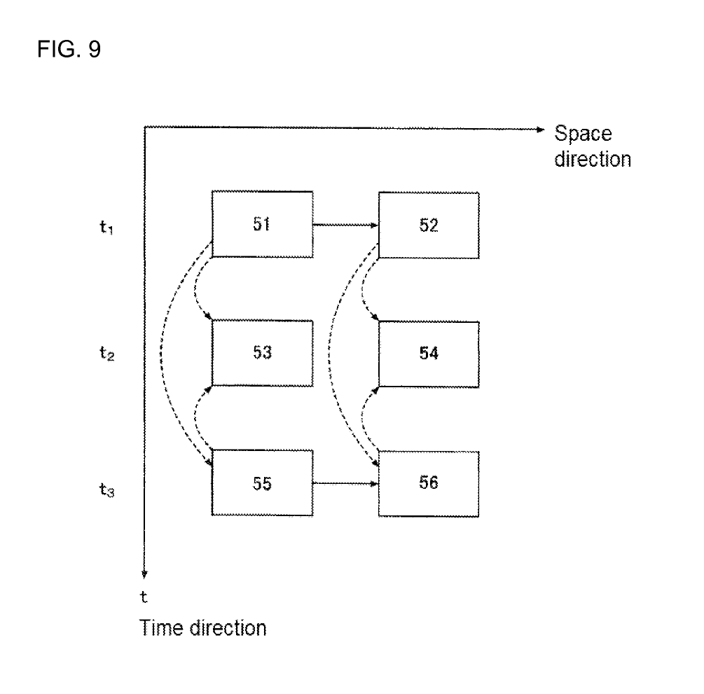

Such multiview image encoding devices, as shown in FIG. 9, for example, first, at time t1, perform intraframe coding of left eye image 51, which is the base view image. Right eye image 52, which is the non-base view image, is interframe coded using parallax compensation with the left eye image 51 as the reference source. Next, at time t3, the left eye image 55 is interframe coded using motion compensation with the previous left eye image 51 as the reference source. Right eye image 56 is interframe coded using motion compensation on the previous right eye image 52 or parallax compensation of the left eye image 55. Next, at time t2, the left eye image 53 is interframe coded with motion compensation using the decoded images of left eye images 51 and 55, which were previously encoded. Right eye image 54 is interframe coded with motion compensation using the decoded images of right eye images 52 and 56, which were previously encoded. In addition, when executing this encoding, prediction error is measured by block matching, and if prediction error exceeds a predetermined threshold, an attempt is made to maintain generational durability by methods such as performing intraframe coding without motion compensation, parallax compensation, etc. (for example, patent document 1).

In general, motion compensation is likely to lower the quality of the predicted picture, compared to the original unpredicted picture. Similarly, asymmetric parallax compensation is likely to lower the quality of the resulting viewpoint image, compared to the reference-source viewpoint image. Therefore, in encoding methods such as MPEG-2 MVP and AVC MVC which use asymmetric parallax compensation, there is a problem in that the other viewpoint used as the non-base view image, for example, the right eye image, is likely to have lower quality than the viewpoint used as the base view image, for example, the left eye image. In order to solve this problem, there has also been disclosed an encoding device which keeps high the quality of the image data used as the base view image by making the size of the quantization step used when quantizing image data used as the base view image be smaller than the size of the quantization step used when quantizing image data used as the non-base view image (for example, patent document 2).

### PRIOR ART DOCUMENTS

### Patent Documents

Patent document 1: JP 10-191394 A

Patent document 2: JP 11-341520 A

Non-patent document 1: Nikkei Electronics, Sep. 22, 2008, “3D Display, the Third Degree of Honesty”

Non-patent document 2: ISO/IEC 13818-2: 2000, “Information technology—Generic coding of moving pictures and associated audio information: Video”

Non-patent document 3: ISO/IEC 13818-7: 2006, “Information technology—Generic coding of moving pictures and associated audio information—Part 7: Advanced Audio Coding (AAC)”

Non-patent document 4: ISO/IEC 14496-10: 2008, “Information technology—Coding of audio-visual objects—Part 10: Advanced Video Coding”

Non-patent document 5: ISO/IEC 14496-10: 2008, “Information technology—Coding of audio-visual objects—Part 10: Advanced Video Coding, AMENDMENT 1: Multiview Video Coding”

Non-patent document 6: ISO/IEC 15444-1: 2004, “Information technology—JPEG 2000 image coding system: Core coding system”

### SUMMARY OF THE INVENTION

### Problems the Invention is to Solve

Nevertheless, even if prediction error is measured by constantly performing block matching and intraframe coding is performed instead of interframe coding when the prediction error exceeds a predetermined threshold as in the encoding device disclosed in patent document 1, if there is continuing high prediction error at a level that does not exceed the threshold, it becomes difficult to maintain generational durability. In addition, if the threshold is set low, the frequency of performing motion compensation and view compensation and so forth decreases, leading to the issue of decreased coding efficiency. In addition, it still is not possible to solve the problem that the quality of the resulting image is likely to be lower than that of the reference-source image.

Also, even if coding is performed so that the quality of the prediction residual of the non-base view approaches the quality of the base view image as in the encoding device disclosed in patent document 2, the quality of the non-base view image is reduced compared to the base view image, and the quality balance between the base view image and the non-base view image becomes nonuniform. Therefore, to the viewer, the load on the eye viewing the non-base view image increases. This sort of asymmetric view compensation has the problem that the quality of the resulting image is likely to be lower than that of the reference-source image.

The present invention was created to solve these problems, so it has the object of providing a stereo image encoding method, stereo image encoding device, and stereo image encoding program, for stereo image data obtained from two different viewpoints, which are unlikely to lose quality when encoding and decoding are repeated, and which have superior generational durability.

### Means for Solving the Problems

According to a first configuration of the present invention, there is provided a stereo image encoding method for encoding image data obtained from two different viewpoints, the method comprising a frequency transformation step in which first image data obtained from a first viewpoint is converted into a first frequency component that is divided according to a predetermined frequency range and resolution and second image data obtained from a second viewpoint is converted into a second frequency component that is divided according to a predetermined frequency range and resolution, a corresponding relationship analysis step in which the aforementioned first image data and the aforementioned second image data are compared and the corresponding relationship thereof is analyzed, a parallax compensation performance step in which, on the basis of the corresponding relationship analyzed in the aforementioned corresponding relationship analysis step, symmetrical parallax compensation using rotation processing is selectively performed on the aforementioned first frequency component and the aforementioned second frequency component, and a parallax-compensated first frequency component and a parallax-compensated second frequency component are obtained, and an encoding step in which, on the basis of the corresponding relationship analyzed in the aforementioned corresponding relationship analysis step, the aforementioned first frequency component, the aforementioned second frequency component, the aforementioned parallax-compensated first frequency component, and the aforementioned parallax-compensated second frequency component are selectively encoded.

As a result of this constitution, the stereo image encoding method of the present invention selectively performs rotation processing on the aforementioned first frequency component and the aforementioned second frequency component, thereby performing symmetrical parallax compensation without handling in which the image of one viewpoint is given precedence compared to the image of the other viewpoint, so it is possible to reduce the difference in quality between the images of different viewpoints, and quality is less likely to decrease when decoding and encoding are repeated, and it is possible to perform stereo image encoding with good generational durability.

In addition, according to the present invention, the aforementioned frequency transformation step may also include a step of performing subband division. By doing so, the stereo image encoding method of the present invention can produce frequency components comprising subband samples divided according to a predetermined frequency range and resolution.

In addition, according to the present invention, the aforementioned corresponding relationship analysis step may also include a step of analyzing the corresponding relationship on the basis of stereo matching. By doing so, the stereo image encoding method of the present invention can obtain three-dimensional information and analyze the corresponding relationship thereof from two-dimensional data: the aforementioned first image data and the aforementioned second image data.

In addition, according to the present invention, the aforementioned corresponding relationship analysis step may also include a step of analyzing the corresponding relationship by comparing the low-resolution frequency components among the aforementioned first frequency component and the aforementioned second frequency component. By doing so, the stereo image encoding method of the present invention can reduce the amount of calculation required for corresponding relationship analysis.

In addition, according to the present invention, the aforementioned corresponding relationship analysis step may also include a step of analyzing the corresponding relationship on the basis of depth information included in the aforementioned first image data and the aforementioned second image data. By doing so, the stereo image encoding method of the present invention can reduce the amount of calculation required for corresponding relationship analysis.

In addition, according to the present invention, the aforementioned corresponding relationship analysis step may also include a step of dividing the aforementioned first frequency component and the second frequency component into parallax compensation blocks and non-parallax-compensation blocks on the basis of the analyzed corresponding relationship, the aforementioned parallax compensation performance step may include a step of performing parallax compensation on the aforementioned parallax compensation blocks of the aforementioned first frequency component and the second frequency component and generating a parallax-compensated first frequency component and a parallax-compensated second frequency component, and the aforementioned encoding step may include a step of independently encoding the parallax-compensated first frequency component and the parallax-compensated second frequency component and the aforementioned first frequency component and the aforementioned second frequency component corresponding to the aforementioned non-parallax-compensated blocks together with division information for the aforementioned parallax-compensated blocks and the aforementioned non-parallax-compensated blocks. By including this sort of information in the bitstream generated by encoding by this stereo image encoding method, the stereo image encoding method of the present invention makes it possible to decode the generated bitstream later using any decoder.

In addition, according to the present invention, the aforementioned division step may execute a method of dividing the same block into subbands with the same resolution, or based on the block division method for a certain subband, the block division method for another subband may be predicted, and the aforementioned encoding step encodes the prediction residual of the block division method for the subband whose block division method was predicted. Here, “block division method” has the same meaning as block division pattern. By doing so, the stereo image encoding method of the present invention, in addition to using the same block division method on subbands with the same resolution, predictively encodes the block division method, thereby reducing the coding amount.

According to a second configuration of the present invention, there is provided a stereo image encoding device for encoding image data obtained from two different viewpoints, the device comprising a frequency transformation unit in which first image data obtained from a first viewpoint is converted into a first frequency component that is divided according to a predetermined frequency range and resolution and second image data obtained from a second viewpoint is converted into a second frequency component that is divided according to a predetermined frequency range and resolution, a corresponding relationship analysis unit in which the aforementioned first image data and the aforementioned second image data are compared and the corresponding relationship thereof is analyzed, a parallax compensation performance unit in which, on the basis of the corresponding relationship analyzed in the aforementioned corresponding relationship analysis unit, symmetrical parallax compensation using rotation processing is selectively performed on the aforementioned first frequency component and the aforementioned second frequency component, and a parallax-compensated first frequency component and a parallax-compensated second frequency component are obtained, and an encoding unit in which, on the basis of the corresponding relationship analyzed in the aforementioned corresponding relationship analysis unit, the aforementioned first frequency component, the aforementioned second frequency component, the aforementioned parallax-compensated first frequency component, and the aforementioned parallax-compensated second frequency component are selectively encoded.

As a result of this constitution, the stereo image encoding device of the present invention selectively performs rotation processing on the aforementioned first frequency component and the aforementioned second frequency component, thereby performing symmetrical parallax compensation without handling in which the image of one viewpoint is given precedence compared to the image of the other viewpoint, so it is possible to reduce the difference in quality between the images of different viewpoints, and quality is less likely to decrease when decoding and encoding are repeated, and it is possible to perform stereo image encoding with good generational durability.

According to a third configuration of the present invention, there is provided a stereo image encoding program for executing stereo image encoding processing that encodes image data obtained from two different viewpoints, the program causing a computer to function as a frequency transformation unit in which first image data obtained from a first viewpoint is converted into a first frequency component that is divided according to a predetermined frequency range and resolution and second image data obtained from a second viewpoint is converted into a second frequency component that is divided according to a predetermined frequency range and resolution, a corresponding relationship analysis unit in which the aforementioned first image data and the aforementioned second image data are compared and the corresponding relationship thereof is analyzed, a parallax compensation performance unit in which, on the basis of the corresponding relationship analyzed in the aforementioned corresponding relationship analysis unit, symmetrical parallax compensation using rotation processing is selectively performed on the aforementioned first frequency component and the aforementioned second frequency component, and a parallax-compensated first frequency component and a parallax-compensated second frequency component are obtained, and an encoding unit in which, on the basis of the corresponding relationship analyzed in the aforementioned corresponding relationship analysis unit, the aforementioned first frequency component, the aforementioned second frequency component, the aforementioned parallax-compensated first frequency component, and the aforementioned parallax-compensated second frequency component are selectively encoded.

As a result of this constitution, the stereo image encoding program of the present invention causes a computer to selectively perform rotation processing on the aforementioned first frequency component and the aforementioned second frequency component, thereby performing symmetrical parallax compensation without handling in which the image of one viewpoint is given precedence compared to the image of the other viewpoint, so it is possible to reduce the difference in quality between the images of different viewpoints, and quality is less likely to decrease when decoding and encoding are repeated, and it is possible to perform stereo image encoding with good generational durability.

### Effect of the Invention

According to the present invention, it is possible to provide a stereo image encoding method, stereo image encoding device, and stereo image encoding program, for a stereo image obtained from two different viewpoints, which are unlikely to lose quality when encoding and decoding are repeated, and which have superior generational durability.

### DETAILED DESCRIPTION OF THE INVENTION

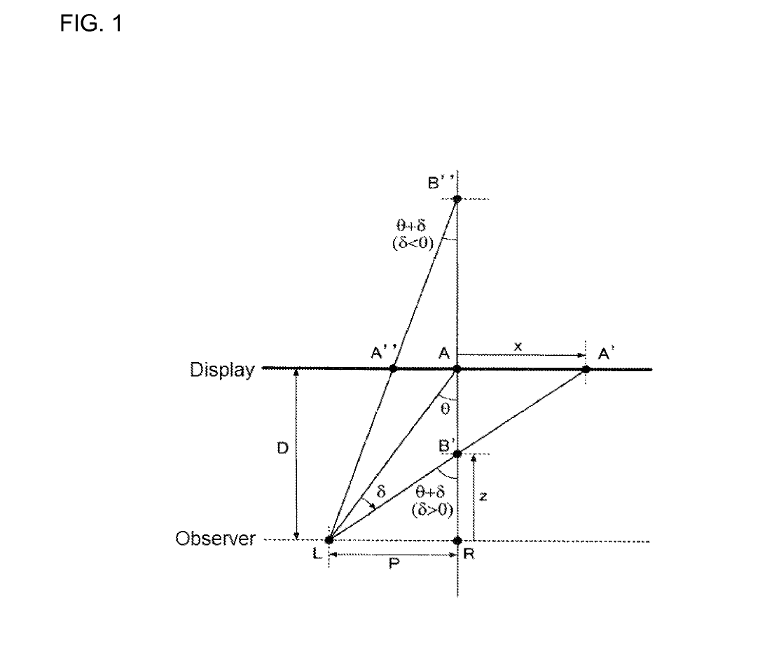

FIG. 1 is a diagram schematically representing the relationship between displacement of left and right images and the depth of the reproduced images in a three-dimensional display.

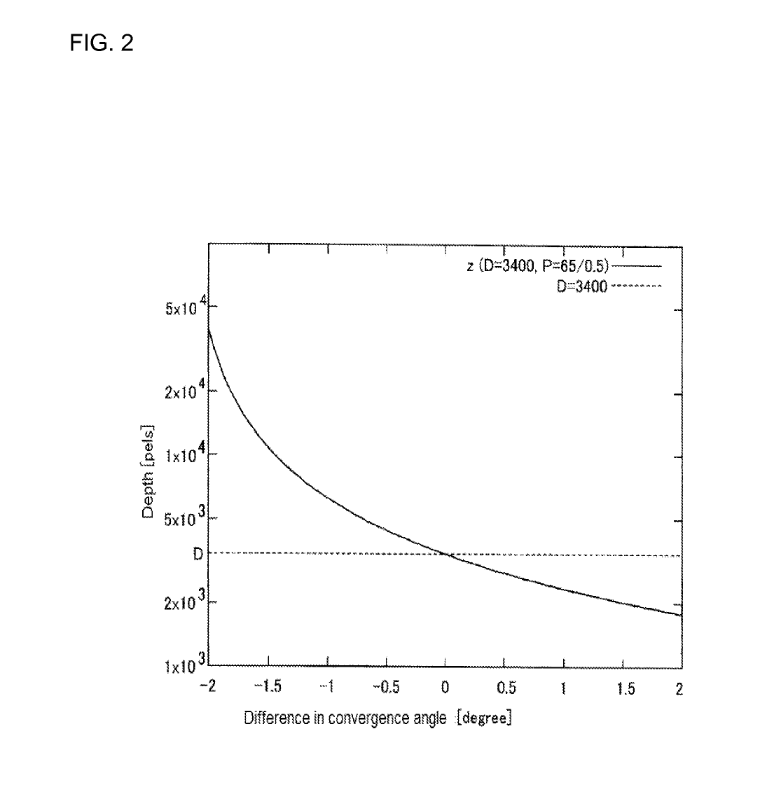

FIG. 2 is a graph showing the relationship between difference in convergence angle and depth of reproduced image in typical parameters.

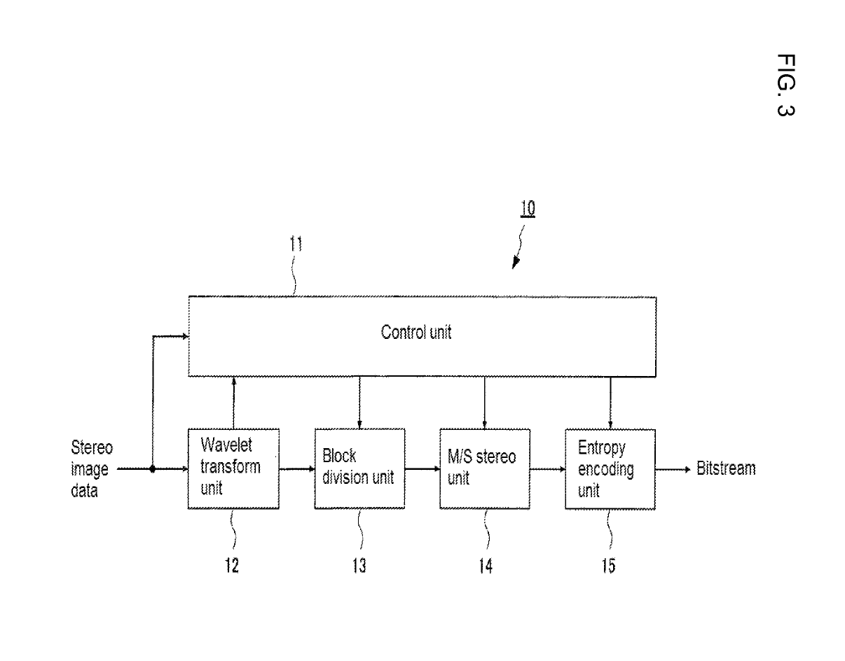

FIG. 3 is a block diagram of a stereo image encoding device in one embodiment of the present invention.

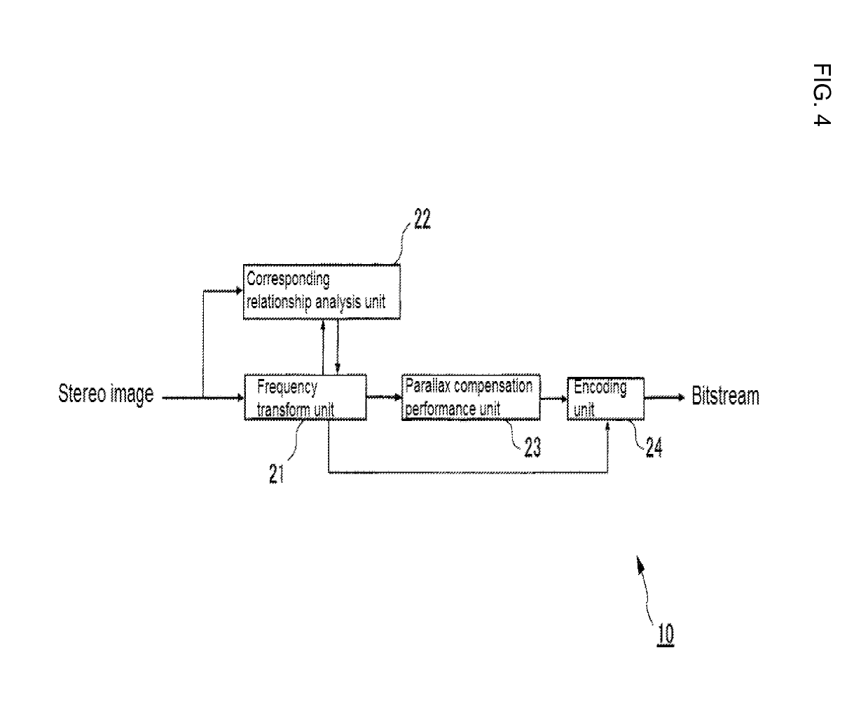

FIG. 4 is a block diagram showing the functional structure of the stereo image encoding device of FIG. 3.

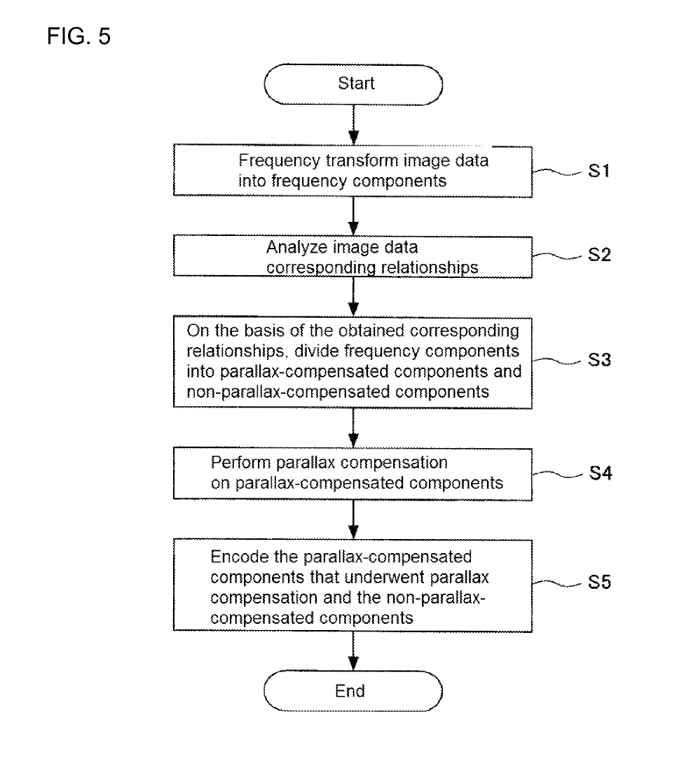

FIG. 5 is a flowchart describing the processing performed by the stereo image encoding device of FIG. 3.

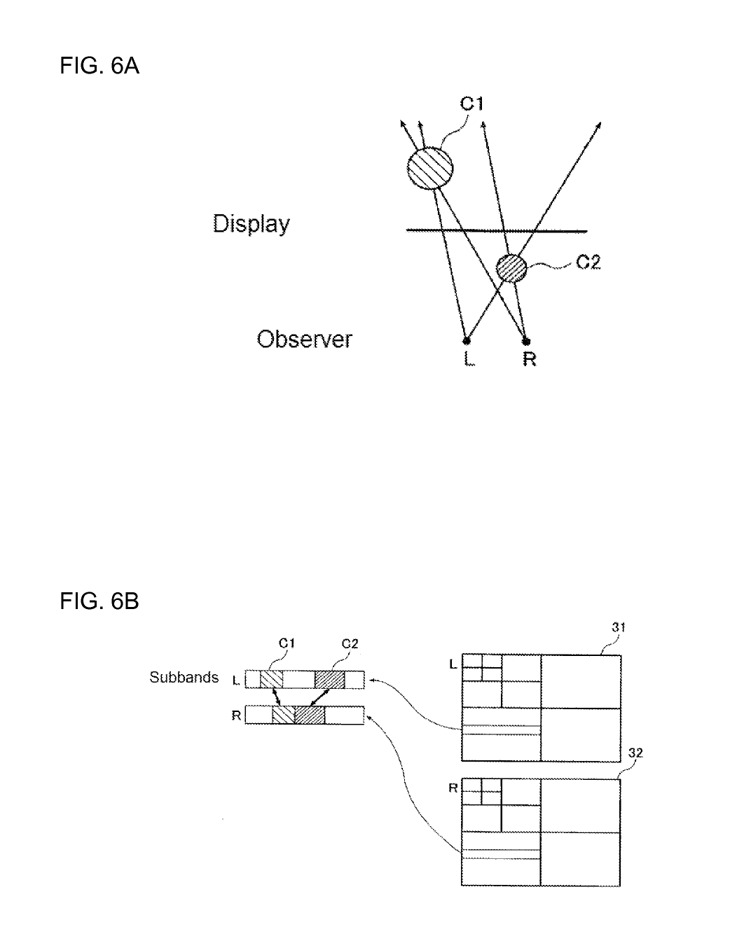

FIG. 6A is a diagram describing an overview of the symmetrical parallax compensation of the present invention.

FIG. 6B is a diagram describing an overview of the symmetrical parallax compensation of the present invention.

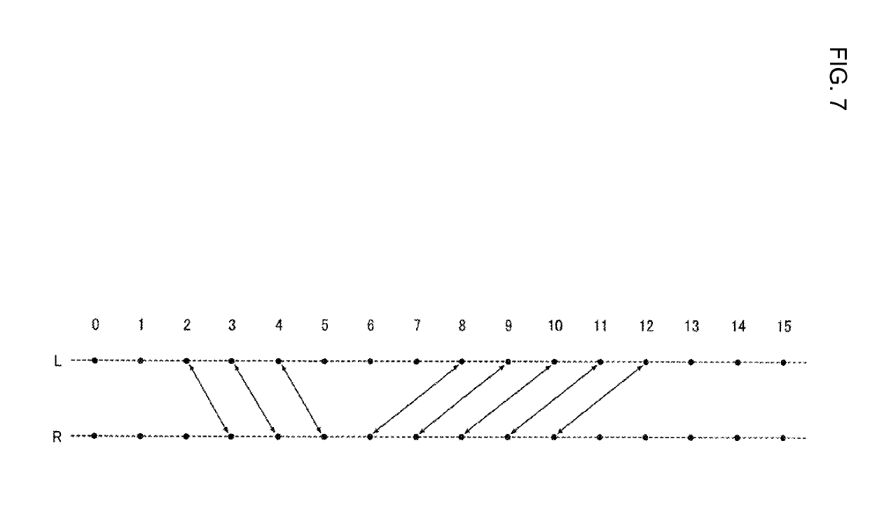

FIG. 7 is a diagram showing one example of the corresponding relationships between subband samples for the left viewpoint and subband samples for the right viewpoint.

FIG. 8 is a diagram describing one example of binocular parallax.

FIG. 9 is a diagram describing conventional multiview image encoding processing.

### CONFIGURATION FOR PRACTICING THE INVENTION

Below, embodiments of the present invention shall be described with reference to the drawings.

### Basic Principle of Symmetrical Parallax Compensation

First, the technique assumed for the parallax compensation of the present invention shall be described.

FIG. 1 is a diagram schematically representing the relationship between x, positional displacement of images, z, the depth of the reproduced images, and δ (delta), the convergence angle difference, in a three-dimensional display which displays an image obtained from two different left and right viewpoints, i.e. a stereo image. For convenience in description, the line of sight of the right eye is made perpendicular to a line passing through the left and right eyes of the observer. When the images corresponding to the left and right eyes are at the same position A on the display, the reproduced image is reproduced at position A. The convergence angle at this time is θ (theta), and convergence angle difference δ is known as crossed parallax. When the convergence angle difference δ is positive, the left eye image is at position A′, and the reproduced image appears to jump out to position B′. When the convergence angle difference δ is negative, the left eye image is at position A″, and the reproduced image withdraws and appears to recede to position B″. The convergence angle difference δ at this time is known as uncrossed parallax.

Now, if we postulate that the absolute values of convergence angle θ and convergence angle difference δ are small enough, the relationship between positional displacement x and reproduced image depth z and convergence angle difference δ [rad] can be represented as follows.

$$x \approx D δ \\ z \approx {( \frac{1}{D} + \frac{δ}{P} )}^{- 1} \qquad Equation 1$$

where viewing distance is D and interocular distance is P.

A typical viewing distance, measured in number of pixels, is about D=3400 [pel]. A typical interocular distance is 65 mm, so if the pixel pitch is 0.5 mm/pel, P=65/0.5=about 130 [pel). Also, the range for the typical convergence angle difference δ, given safety considerations, is thought to be about ±2 degrees. With these typical parameters, displacement x on the display becomes about ±120 [pel]. Also, it is necessary that x be >−P so that the reproduction position is reproduced correctly without diverging.

FIG. 2 is a graph showing the relationship between convergence angle difference δ and reproduced image depth z in typical parameters. Here, the range of δ is ±2 degrees. As shown in FIG. 2, when the convergence angle difference δ is positive, i.e. in crossed parallax, the reproduced image recedes, and when the convergence angle difference δ is negative, i.e. in uncrossed parallax, the reproduced image jumps out; the boundary is indicated by the dotted line, where D=3400 [pel]. Thus, we see that according to convergence angle difference δ, the reproduced image can be made to jump out to a position that is about half the viewing distance, or can be made to recede sufficiently far.

Based on the above, we see that the positional displacement of the left and right images on the display is typically wider than the width of a DCT block. Therefore, in a codec that uses the DCT transform the correlation between the DCT blocks of the left and right image for the same display position is not high, so parallax compensation is necessary. The present invention performs symmetrical parallax compensation on the images obtained from two different viewpoints in order to solve this problem of the prior art.

However, for the following reasons, it appears to be difficult to efficiently combine a codec using the DCT transform and symmetrical parallax compensation. First, in order to perform symmetrical parallax compensation, it is necessary to find blocks with correlation between the left and right images, but in a codec that uses the DCT transform the starting position of the transform block is limited to an integral multiple of the transform block width, so it is difficult to accurately find correlated blocks. Also, if the transform block width is made small, coding efficiency decreases, and conversely, if the transform block width is made large, problems such as mosquito noise become apparent. In addition, if the transform block width is made irregular, processing becomes complicated. Therefore, in a codec that uses the DCT transform it is not possible to perform symmetrical parallax compensation with high precision.

Therefore, the encoding processing of the representative embodiment of the present invention that will be explained next executes the wavelet transform that is used in JPEG 2000 (see non-patent document 6), for example. The JPEG 2000 wavelet transform is executed as a subband transform; recursively decomposing a low-frequency frequency component generates a plurality of subbands each having a predetermined resolution and a predetermined frequency component. Each of these subbands is divided into encoding blocks and independently encoded. Therefore, unlike a codec that uses the DCT transform, the frequency transformation unit and decoding unit do not match, so encoding blocks can be divided in a more flexible manner. In the representative embodiment of the present invention, parallax compensation is performed at the unit of this encoding block.

### Representative Embodiment of the Present Invention

FIG. 3 is a block diagram of a stereo image encoding device 10 in one embodiment of the present invention. The stereo image encoding device 10 of this embodiment includes a control unit 11, a wavelet transform unit 12, a block division unit 13, an M/S (Mid/Side) stereo processing unit 14, and an entropy encoding unit 15.

The control unit 11 analyzes the corresponding relationships of the inputted stereo image data, and controls the block division unit 13, M/S stereo processing unit 14, and entropy encoding unit 15 on the basis of the obtained analysis relationships. The wavelet transform unit 12 executes a wavelet transform on stereo image data comprising right viewpoint image data and left viewpoint image data, and generates a plurality of subbands.

The block division unit 13, on the basis of the analysis results for corresponding relationships performed by the control unit 11, divides the subbands generated by the wavelet transform unit 12 into parallax compensation blocks to undergo parallax compensation and non-parallax-compensation blocks that will not undergo parallax compensation. The M/S stereo processing unit 14, on the basis of the analysis results for corresponding relationships performed by the control unit 11, performs M/S stereo processing on the blocks determined to be parallax compensation blocks among the blocks that were divided by the block division unit 13, but the non-parallax-compensation blocks are output without modification to the entropy encoding unit 15. The entropy encoding unit 15, on the basis of the analysis results for corresponding relationships performed by the control unit 11, independently performs the respective entropy encoding on the blocks that were divided by the block division unit 13: parallax compensation blocks that underwent M/S stereo processing by the M/S stereo processing unit 14, blocks determined to be non-parallax-compensation blocks, and information on the block division performed by the block division unit 13, and outputs a bitstream.

Now, it is also possible to configure matters so that the wavelet transform unit 12 inputs the low-resolution images generated in the course of wavelet transformation to the control unit 11, and the control unit 11 finds the corresponding relationships of samples constituting the left and right stereo image data on the basis of this inputted low-resolution image information. The control unit 11, on the basis of corresponding relationships found in this manner, controls the block division unit 13 and the M/S stereo processing unit 14, and also outputs the block division method to the entropy encoding unit.

FIG. 4 is a block diagram showing the function structure of the stereo image encoding device of FIG. 3. In this embodiment, the stereo image encoding device includes a frequency transformation unit 21, a corresponding relationship analysis unit 22, a parallax compensation performance unit 23, and an encoding unit 24.

The frequency transformation unit 21 comprises the wavelet transform unit 12 and the block division unit 13 of FIG. 3; based on data for a stereo image obtained from two different viewpoints, it converts first image data for a first viewpoint, obtained from the left eye, for example, into a first frequency component divided according to a predetermined frequency range and resolution, and second image data for a second viewpoint, obtained from the right eye, for example, into a second frequency component divided according to a predetermined frequency range and resolution.

The corresponding relationship analysis unit 22 comprises the control unit 11 of FIG. 3; it compares a first subband sample block and a second subband sample block, and analyzes the corresponding relationship. The parallax compensation performance unit 23 comprises the M/S stereo processing unit 14; on the basis of the corresponding relationships analyzed by the corresponding relationship analysis unit 22, it selectively performs symmetrical parallax compensation using rotation processing on the first frequency component and the second frequency component, and obtains a parallax-compensated first frequency component and a parallax-compensated second frequency component.

The encoding unit 24, on the basis of the corresponding relationships analyzed by the corresponding relationship analysis unit 22, selectively encodes the first frequency component, the second frequency component, the parallax-compensated first frequency component, and the parallax-compensated second frequency component.

More specifically, the frequency transformation unit 21 performs subband division, and in addition, on the basis of the corresponding relationships analyzed by the corresponding relationship analysis unit 22, it performs block division of subband sample blocks that have undergone parallax compensation and subband sample blocks that have not undergone parallax compensation.

Also, the corresponding relationship analysis unit 22 can analyze the corresponding relationships between first subband sample blocks that are the first frequency component and second subband sample blocks that are the second frequency component on the basis of stereo matching, for example. In addition, the corresponding relationship analysis unit 22 may be configured to compare low-resolution frequency components among the first frequency component and the second frequency component, and analyze the corresponding relationships thereof, and may also be configured to analyze the corresponding relationships on the basis of depth information included in the first image data and second image data. Also, it is possible to configure matters so that matching is performed under restrictive conditions such as conditions that minimize as much as possible non-matching regions, i.e. occlusion regions where the region of an object that can be seen from one viewpoint is concealed by the region of an object seen from another viewpoint.

Next, the processing performed by the stereo image encoding device 10 of this embodiment, constituted in this manner, shall be described with reference to FIG. 5. Furthermore, the following processing is executed according to a CPU that is included in the stereo image encoding device 10 but not shown in the drawings, and by software associated with the CPU.

In step S1, the frequency transformation unit 21, based on data for a stereo image obtained from two different viewpoints, converts first image data for a first viewpoint, obtained from the left eye, for example, into a first frequency component divided according to a predetermined frequency range and resolution, and second image data for a second viewpoint, obtained from the right eye, for example, into a second frequency component divided according to a predetermined frequency range and resolution. In this embodiment the frequency transformation unit 21 obtains subbands by performing frequency conversion of the image data of the stereo image using a wavelet transform.

In step S2, the corresponding relationship analysis unit 22 compares the first image data and the second image data, and analyzes the corresponding relationship. Specifically, the corresponding relationship analysis unit 22 analyzes the corresponding relationship of stereo image data.

In more detail, the corresponding relationship analysis unit 22 analyzes the corresponding relationships by comparing first subband sample blocks in the first frequency component and the second subband sample blocks in the second frequency component. The corresponding relationship between the first subband sample blocks and the second subband sample blocks can be analyzed based on stereo matching, for example. By doing so, it is possible to obtain three-dimensional information and analyze the corresponding relationship from two-dimensional data: the first subband sample blocks and the second subband sample blocks. In addition, the corresponding relationship analysis unit 22 may be configured to compare low-resolution frequency components among the first frequency component and the second frequency component, and analyze the corresponding relationships thereof, and may also be configured to analyze the corresponding relationships on the basis of depth information included in the first image data and second image data. Also, it is possible to configure matters so that matching is performed under restrictive conditions such as conditions that minimize as much as possible non-matching regions, i.e. occlusion regions where the region of an object that can be seen from one viewpoint is concealed by the region of an object seen from another viewpoint. By doing so, it is possible to reduce the amount of calculation required for corresponding relationship analysis.

In step S3, based on the corresponding relationships analyzed in the aforementioned corresponding relationship analysis step, the first frequency component and the second frequency component are divided into a parallax compensation component and a non-parallax-compensation component. In the present embodiment, the corresponding relationship analysis unit 22 divides subbands into parallax compensation blocks and non-parallax-compensation blocks on the basis of the obtained corresponding relationships.

Specifically, on the basis of the corresponding relationships analyzed by the corresponding relationship analysis unit 22, the frequency transformation unit 21 sends the subband sample blocks determined to have a corresponding relationship among the first subband sample in the first frequency component and the second subband sample in the second frequency component to the parallax compensation performance unit 23 as the parallax compensation blocks that are the parallax compensation component, and sends the sample blocks determined to not have a corresponding relationship to the encoding unit 24 without modification as non-parallax-compensation blocks that are the non-parallax-compensation component.

In step S4, the parallax compensation performance unit 23 performs symmetrical parallax compensation on the parallax compensation component, i.e. the parallax compensation blocks.

In step S5, the encoding unit 24 independently encodes the non-parallax-compensation component and the parallax compensation component that underwent parallax compensation that it was sent.

Referring to FIG. 6A and FIG. 6B, the analysis of corresponding relationships, division into a parallax compensation component and a non-parallax-compensation component, and symmetrical parallax compensation and encoding performed by the stereo image encoding device 10 of this embodiment shall be described in detail.

FIG. 6A shows one example of a stereo image comprising a right viewpoint image and a left viewpoint image that is encoded by the stereo image encoding device 10. Subjects that seem different in depth (see z in FIG. 1) are present at different positions with respect to the left and right viewpoints. In FIG. 6A, C1 is a reproduced image that appears to jump out due to uncrossed parallax in the three-dimensional display, and C2 is a reproduced image that appears to recede due to crossed parallax. FIG. 6B shows an example in which the frequency transformation unit 21 has carried out subband conversion on the stereo image of FIG. 6A and generated left (L) viewpoint subband 31 and right (R) viewpoint subband 32 and split these into blocks with a corresponding relationship; then parallax compensation is performed. In the symmetrical parallax compensation of this embodiment, subbands are divided into stripes of appropriate height, and these stripes are additionally divided into blocks.

Now, the height of stripe from which a block is cut may be the same for all subbands, or may be variable. In a stripe, rows that have samples with a corresponding relationship and parallax that is essentially equal are combined, and constitute a parallax compensation block. The parallax compensation block must be constituted so that left and right form a pair, and pairs of blocks do not overlap. In FIG. 6B, blocks related to reproduced image C1 and reproduced image C2 are divided and extracted. According to the present invention, blocks with a corresponding relationship undergo symmetrical parallax compensation as parallax compensation blocks and are encoded, and other blocks that not determined to have a corresponding relationship become non-parallax-compensation blocks that are not subjected to parallax compensation, and are encoded without modification.

In this embodiment, the M/S stereo (Mid/Side Stereo) processing used in AAC (see non-patent document 3), etc. is used as symmetrical parallax compensation. Specifically, instead of independently encoding the left and right image blocks that are to be parallax compensated by independently encoding the corresponding left sample L and the right sample R, encoding is performed using the total M of the corresponding left sample L and right sample R and difference S. Conversion from L and R to M and S is defined below. Conversion from L and R to M and S is equivalent to processing in which the left sample L and right sample R are rotated by a predetermined angle, which is a 45° angle in this embodiment.

$$[ \begin{matrix}M \\ S\end{matrix} ] = \frac{1}{\sqrt{2}} [ \begin{matrix}1 & 1 \\ 1 & - 1\end{matrix} ] [ \begin{matrix}L \\ R\end{matrix} ] \qquad Equation 2$$

Reverse conversion is defined in the same manner.

The corresponding relationship analysis unit 22 determines whether or not the blocks of the subbands 31 and 32 for the left and right images are blocks with a corresponding relationship on the basis of left and right image matching or stereo matching. Stereo matching is a method for finding the corresponding relationship for each sample (including pixel and subband samples) by methods such as template-based matching and feature-based matching. In order to increase the precision of matching, the corresponding relationship analysis unit 22 can be configured so that matching is performed under restrictive conditions such as conditions that minimize as much as possible non-matching regions, i.e. occlusion regions where the region of an object that can be seen from one viewpoint is concealed by the region of an object seen from another viewpoint. Also, in order to reduce the calculation amount for matching, the corresponding relationship analysis unit 22 can be configured to utilize multi-resolution analysis with wavelet transform and predict corresponding relationships at high resolution on the basis of corresponding relationships found in low resolution images. Also, if depth information such as a depth map, for example, is attached to the left and right viewpoints, it is possible to configure matters so that the corresponding relationship is found using this depth information as a clue.

FIG. 7 shows an example of the corresponding relationship between a set L of left viewpoint subband samples and a set R of right viewpoint subband samples. In FIG. 7, the subband has a width of 16 samples, and arrows represent the corresponding relationship between left and right samples. Samples without arrows indicate there is no corresponding relationship. For example, the second sample of L and the third sample of R correspond, but the first sample of L does not have a corresponding relationship with an R subband sample. Also, the second through fourth samples of L have the same parallax. A pair of samples having this sort of corresponding relationship is combined as a parallax compensation block (written L [2, 4]). The corresponding third through fifth samples of R are also combined as a parallax compensation block (written R [3, 5]). L [2, 4] and R [3, 5] form a pair for symmetrical parallax compensation. Similarly, L [8, 12] and R [6, 10] form a paired parallax compensation block. The other blocks, L [0, 1], L [5, 7], L [13, 15], R [0, 2], R [11, 15], do not form pairs and become non-parallax-compensation blocks.

The encoding unit 24 independently encodes the non-parallax-compensation component and the parallax compensation component that is parallax compensated. In this embodiment, the non-parallax-compensation component, i.e. the first frequency component and the second frequency component that were divided into non-parallax-compensation blocks, is the left sample L and the right sample R, and the parallax compensation component that is parallax compensated is the total M and difference S generated by applying M/S stereo processing to the left sample L and the right sample R that were divided into parallax compensation blocks.

This embodiment applies symmetrical parallax compensation, specifically, M/S stereo processing, to the parallax compensation blocks. Samples that do not belong to a parallax compensation block are combined in non-parallax-compensation blocks. Non-parallax-compensation blocks are independently encoded without being paired. Parallax compensation blocks and non-parallax-compensation blocks may be further divided in order to more finely optimize rate distortion. In order to perform the same block division as the encoder at the decoder, it is necessary to include information on the block division method in the encoded bitstream. In order to reduce the amount of coding, matters may be configured so as to use the same block division method for the same resolution, i.e. for subbands with the same decomposition level.

Also, matters may be configured so as to predict the block division method for bands with low resolution, i.e. a high decomposition level, based on the block division method for bands with high resolution, i.e. a low decomposition level, and to encode only the prediction residual. For example, it is possible to calculate the block division method for a stripe in a low-resolution band based on the stripe division method for one or more high-resolution bands corresponding to that stripe, based on the corresponding relationship of samples in the stripe of the low-resolution band, predicted so as to produce a central value, for example. When doing so, if the predicted corresponding relationship differs from the actual corresponding relationship of the sample, by encoding that difference, i.e. the prediction residual, and including it in the stream, it is possible to obtain the correct corresponding relationship and to obtain the correct block division method. Using the same technique, it is also possible to predict the block division method for bands with high resolution, i.e. a low decomposition level, based on the block division method for bands with low resolution, i.e. a high decomposition level. Also, using the same method, more generally, it is possible to predict one block division method from the block division method for another subband. Therefore, given a subband which includes parallax compensation blocks and non-parallax-compensation blocks, and a plurality of blocks of the first frequency component and the second frequency component, it is possible to execute the same block division method in subbands with the same resolution, or to predict the block division method for one subband on the basis of the block division method for another subband, and the encoding step can encode only the prediction residual of the block division method for the subband whose block division method was predicted. Here, “block division method” has the same meaning as block division pattern.

Specifically, given a subband which includes blocks that underwent parallax compensation in step S4 described above and blocks determined to be non-parallax-compensation blocks in step S3, matters may be configured so that in step S5 the control unit 10 [sic] encodes only the prediction residual of the block division method for the subband whose block division method was predicted. By doing so, in addition to using the same block division method for a subband with the same resolution, becomes possible to reduce even more the amount of coding through predictive encoding of the block division method.

In addition, the stereo image encoding method of this embodiment selectively performs rotation processing on the first frequency component that is the subband sample of one viewpoint and the second frequency component that is the subband sample of another viewpoint, thereby performing symmetrical parallax compensation without handling in which the image of one viewpoint is given precedence compared to the image of the other viewpoint, so it is possible to reduce the difference in quality between the images of different viewpoints, and quality is less likely to decrease when decoding and encoding are repeated, and it is possible to perform stereo image encoding with good generational durability.

As described above, the stereo image encoding device of this embodiment uses symmetrical parallax compensation instead asymmetrical parallax compensation, and therefore can reduce the difference in quality between different viewpoints by performing symmetrical coding without handling in which the image of one viewpoint is given precedence compared to the image of the other viewpoint. However, if it is difficult to make the frame used for symmetrical parallax compensation be the result of motion compensation, it can be made the reference source, so symmetrical parallax compensation may be used mainly only in I frame. Also, when performing symmetrical parallax compensation, it is preferred to use a larger block rather than a relatively small transformation block such as DCT. In addition, the difference in quality between viewpoints can be made small, so quality is less likely to decrease when decoding and encoding are repeated, and generational durability improves. Therefore, it may be used as an editing codec by using only the I frame.

Also, if the present invention is practiced using a computer, it may be implemented as hardware or as a program that executes the functions described above, or it may be implemented as a computer readable storage medium which stores a program for executing the functions described above on a computer. Thus, according to the present invention, it is possible to provide a stereo image encoding method, encoding device, and encoding program that are simpler and more effective.

In the foregoing, an embodiment of the present invention was described, but the present invention is not limited to the embodiment described above. Also, the described effect of the embodiment of the present invention is merely a list of the most optimal effects created by the present invention; the effects due to the present invention are not limited to what is described in the embodiment of the invention.

For example, the embodiment described above was described with reference to the JPEG 2000 system as one example of an encoding system, but encoding systems for which the present invention is suitable are not limited to the JPEG 2000 system. The present invention can be applied to almost any encoding system that performs subband division.

### Legend

10 Stereo image encoding device

11 Control unit

12 Wavelet transform unit

13 Block division unit

14 M/S stereo unit

15 Entropy encoding unit

21 Frequency transformation unit

22 Corresponding relationship analysis unit

23 Parallax compensation performance unit

24 Encoding unit

1. A stereo image encoding method for encoding image data obtained from two different viewpoints, the method comprising:
a frequency transformation step in which first image data obtained from a first viewpoint is converted into a first frequency component that is divided according to a predetermined frequency range and resolution and second image data obtained from a second viewpoint is converted into a second frequency component that is divided according to a predetermined frequency range and resolution,
a corresponding relationship analysis step in which said first image data and said second image data are compared and the corresponding relationship thereof is analyzed,
a parallax compensation performance step in which, on the basis of the corresponding relationship analyzed in said corresponding relationship analysis step, symmetrical parallax compensation using rotation processing is selectively performed on said first frequency component and said second frequency component, and a parallax-compensated first frequency component and a parallax-compensated second frequency component are obtained,
and an encoding step in which, on the basis of the corresponding relationship analyzed in said corresponding relationship analysis step, said first frequency component, said second frequency component, said parallax-compensated first frequency component, and said parallax-compensated second frequency component are selectively encoded.

2. The stereo image encoding method of claim 1, wherein said frequency transformation step includes a step of performing subband division.

3. The stereo image encoding method of claim 1, wherein said corresponding relationship analysis step includes a step of analyzing corresponding relationships based on stereo matching.

4. The stereo image encoding method of claim 1, wherein said corresponding relationship analysis step includes a step of analyzing corresponding relationships by comparing the low-resolution frequency components among said first frequency component and said second frequency component.

5. The stereo image encoding method of claim 1, wherein said corresponding relationship analysis step includes a step of analyzing corresponding relationships on the basis of depth information included in said first image data and said second image data.

6. The stereo image encoding method of claim 1, wherein said corresponding relationship analysis step includes a step of dividing said first frequency component and the second frequency component into parallax compensation blocks and non-parallax-compensation blocks on the basis of the analyzed corresponding relationship,
said parallax compensation performance step includes a step of performing parallax compensation on said parallax compensation blocks of said first frequency component and the second frequency component and generating a parallax-compensated first frequency component and a parallax-compensated second frequency component,
and said encoding step includes a step of independently encoding the parallax-compensated first frequency component and the parallax-compensated second frequency component and said first frequency component and said second frequency component corresponding to said non-parallax-compensated blocks together with division information for said parallax-compensated blocks and said non-parallax-compensated blocks.

7. The stereo image encoding method of claim 6, wherein said division step executes a method of dividing the same block into subbands with the same resolution, or predicts the block division method for one subband based on based on the block division method for another subband,
and said encoding step encodes the prediction residual of the block division method for the subband whose block division method was predicted.

8. A stereo image encoding device for encoding image data obtained from two different viewpoints, the device comprising:
a frequency transformation unit in which first image data obtained from a first viewpoint is converted into a first frequency component that is divided according to a predetermined frequency range and resolution and second image data obtained from a second viewpoint is converted into a second frequency component that is divided according to a predetermined frequency range and resolution,
a corresponding relationship analysis unit in which said first image data and said second image data are compared and the corresponding relationship thereof is analyzed,
a parallax compensation performance unit in which, on the basis of the corresponding relationship analyzed in said corresponding relationship analysis unit, symmetrical parallax compensation using rotation processing is selectively performed on said first frequency component and said second frequency component, and a parallax-compensated first frequency component and a parallax-compensated second frequency component are obtained,
and an encoding unit in which, on the basis of the corresponding relationship analyzed in said corresponding relationship analysis unit, said first frequency component, said second frequency component, said parallax-compensated first frequency component, and said parallax-compensated second frequency component are selectively encoded.

9. A stereo image encoding program for executing stereo image encoding processing that encodes image data obtained from two different viewpoints, the program causing a computer to function as:
a frequency transformation unit in which first image data obtained from a first viewpoint is converted into a first frequency component that is divided according to a predetermined frequency range and resolution and second image data obtained from a second viewpoint is converted into a second frequency component that is divided according to a predetermined frequency range and resolution,
a corresponding relationship analysis unit in which said first image data and said second image data are compared and the corresponding relationship thereof is analyzed,
a parallax compensation performance unit in which, on the basis of the corresponding relationship analyzed in said corresponding relationship analysis unit, symmetrical parallax compensation using rotation processing is selectively performed on said first frequency component and said second frequency component, and a parallax-compensated first frequency component and a parallax-compensated second frequency component are obtained,
and an encoding unit in which, on the basis of the corresponding relationship analyzed in said corresponding relationship analysis unit, said first frequency component, said second frequency component, said parallax-compensated first frequency component, and said parallax-compensated second frequency component are selectively encoded.
